(19) United States
(12) Patent Application Publication
(10) Pub. No.: US 2007/0168454 A1
(43) Pub. Date: Jul. 19, 2007

(54) System and method for host-to-host communication

(75) Inventors: Shmuel Ben-Yehuda, Haifa (IL); Zorik MacHulsky, Gesher HaZiv (IL); Julian Satran, Atlit (IL); Leah Shalev, Zichron-Yaakov (IL); Ilan Shimony, Haifa (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/334,833

(22) Filed: Jan. 19, 2006

(51) Int. Cl. G06F 15/167

(52) U.S. Cl. 709/213

(57) ABSTRACT

A system and method for host-to-host communication are provided in the present invention. The system may include a first host of at least one consumer application, the host may be arranged to allow the consumer to communicate with a second consumer coupled with a second host. The system may further include a network arranged to connect the first and second hosts, and a host-to-host device controller arranged to control communication protocols between the first and second hosts to allow the first and second consumers to communicate with each other.

### CROSS REFERENCE TO RELATED APPLICATIONS

The present invention is related to U.S. Patent Application Ser. No. [Attorney docket IL920050027US1], titled “A METHOD AND SYSTEM FOR MEMORY PROTECTION AND SECURITY USING CREDENTIALS”, filed on Jan. 17, 2006, and also related to U.S. Patent Application Ser. No. [Attorney docket IL920050028US1], titled “A METHOD AND SYSTEM FOR PROTECTION AND SECURITY of IO DEVICES USING CREDENTIALS”, filed on Jan. 17, 2006.

### FIELD OF THE INVENTION

The present invention relates generally to the field of computer and processor architecture. In particular, the present invention relates to a system and method for host-to-host communication.

### BACKGROUND OF THE INVENTION

Fast, efficient and secure mechanism for message passing and remote direct memory access is required, amongst many fields in computer science, in the field of High Performance Computing (HPC) applications and databases. HPC is a branch of computer science that concentrates on developing supercomputers and software to run on supercomputers. A main area of this branch is developing parallel processing algorithms and software, for example, to allow programs to be divided into little pieces of code so that each piece can be executed simultaneously by a separate processing node.

Some technologies, for example, the iWARP multiprocessing supercomputer jointly developed by Intel Corp. (Santa Clara, Calif.) and Carnegie Mellon University, attempt to provide solutions for these needs. However, the current solutions typically suffer from drawbacks related, inter alia, to the security and memory protection of the hosts or consumers of these systems and technologies.

For example, a proposed solution to protect memory regions and messages queues of hosts is by using memory tags. However, memory tags can be easily faked and reused in various attacks, resulting in harmed host memory. This problem is even more crucial in virtualized systems where many operating systems share the same memory.

### SUMMARY OF THE INVENTION

Embodiments of the present invention may provide a system and method for host-to-host communication.

According to a first aspect of the present invention there is provided a system for host to host communication. The system may include a first host of at least one consumer application, the host may be arranged to allow the consumer to communicate with a second consumer coupled with a second host. The system may further include a network arranged to connect the first and second hosts, and a host-to-host device controller arranged to control communication protocols between the first and second hosts to allow the first and second consumers to communicate with each other.

According to a second aspect of the present invention there is provided a computer implemented method for establishing a communication between a first consumer application which is located on a first host to a second consumer application which is located on a second host. The method may include: creating an anonymous connection resource allocation on behalf of the first consumer application on a virtual device of the first consumer application; granting the first consumer application a resource credential from a first type, the resource credential allows execution of operations on the virtual device; and upon receipt of a connection request from the second consumer application, sending an instruction to the second consumer application based on a policy of the first consumer application.

According to a third aspect of the present invention there is provided a method for advertising a first memory region of a first consumer application which is located on a first host for a read and write remote direct memory access (RDMA) operations from a second consumer application which is located on a second host to said first memory region.

The method may include sending an IO request from a first type to a host-to-host device controller to advertise the first memory region; generating a memory window credential (CAP_{W}) of the first memory region; sending the IO request and the CAP_{W} to a virtual device of the first consumer application, the virtual devise is located on the host-to-host device controller. The method may further include creating a memory region resource on the first virtual device, the first virtual device is coupled with said CAP_{W}, generating a device credential to allow access to the first memory region resource, and sending the device credential to the second consumer application.

### BRIEF DESCRIPTION OF THE DRAWINGS

Embodiments of the present invention will now be described, by way of examples only, with reference to the accompanying drawings in which:

FIG. 1 is a schematic block diagram of a logical structure of a system for host-to-host communication, in accordance with an embodiment of the present invention;

FIG. 2 is a flow chart diagram of a method for establishing a connection between two consumer applications, in accordance with an embodiment of the present invention;

FIG. 3 is a schematic block diagram of system for host-to-host multicast communication, in accordance with an embodiment of the present invention;

FIG. 4 is a schematic flow chart diagram of a method for memory advertising, in accordance with an exemplary embodiment of the present invention;

FIG. 5 is a flow chart diagram of a method for remote direct memory access write operation, in accordance with an exemplary embodiment of the present invention; and

FIG. 6 is a flow chart diagram of a method for remote direct memory access read operation, in accordance with an exemplary embodiment of the present invention.

### DESCRIPTION OF EMBODIMENTS OF THE PRESENT INVENTION

### Overview

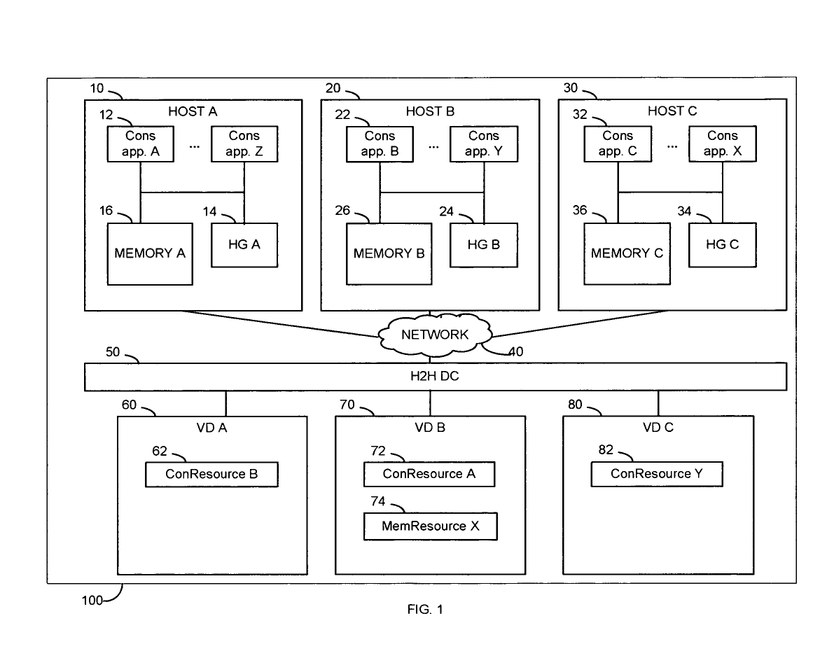

Reference is now made to FIG. 1 which is a schematic block diagram of a logical structure of a system 100 for host-to-host communication, in accordance with an embodiment of the present invention. In the following detailed description the term “consumer” will be used to describe an operating system/partition, a processing node, an application, etc., which are allowed to access an IO device or another consumer.

System 100 may includes hosts, for example, hosts A 10, host B 20, and host C 30, that may be connected to each other and to external systems through a network 40 and they may also be connected to a host-to-host device controller 50. Depending on the specific application, network 40 may be, for example, an Infiniband high-speed serial computer bus, a Gigabit Ethernet, a high-speed local area networking system such as the Myrinet® network, developed by Myricom, Inc. (Arcadia, Calif.), or any other type of fast interconnect network.

Consumers A 12, B 22, and C 32 may be part of hosts A, B, and C, respectively. As shown in FIG. 1, a host is defined by the host gateway (HG) which is coupled with the consumers that are part of that host. For example, host A 10 may include consumers 12 (A until Z) that may be coupled with HG A 14. It should be noted that HG's A, B, and C may cryptographically sign and verify capability credentials of data intended for transmission to the memory unit(s) coupled with them, e.g., memory unit 16 which may be coupled with HG A 14.

Additional details about the functionality of the host gateway component are described in details in U.S. Ser. U.S. Patent Application Ser. No. [Attorney docket IL920050027US1], titled “A METHOD AND SYSTEM FOR MEMORY PROTECTION AND SECURITY USING CREDENTIALS”, and in U.S. Patent Application Ser. No. [Attorney docket IL920050028US1], titled “A METHOD AND SYSTEM FOR PROTECTION AND SECURITY of IO DEVICES USING CREDENTIALS”, both filed on Jan. 17, 2006, assigned to the common assignee of the present invention, and incorporated herein by reference.

Memory units 16, 26 and 36 are logically coupled with each HG. Each memory unit may include smaller memory sections that are coupled with the consumer applications (not shown).

Host-to-Host Device Controller 50 may control the communication protocols between the various hosts of system 100. The device 50 may be shared by hosts 10, 20 and 30, to allow the consumer applications to communicate with each other. It may be implemented as an independent component in system 100 as shown in FIG. 1, but it should be noted, that it may also be implemented as a part of each HG or as a separated component within each host. Alternatively, it may be coupled with other components that are part of each host, that are not shown in FIG. 1.

Each consumer application willing to receive messages from other consumer applications and willing to advertise its memory for direct memory access by other consumers may create a virtual device (VD) on host-to-host device controller 50 in accordance with an embodiment of the present invention. To create such a virtual device (VD), e.g., VD A 60, the initiating consumer, e.g., consumer A 12, may be required to get a device credential from a management entity, such as, for example, the resource manager component which is described in U.S. Application Ser. No. [IL920050028US1, titled “A METHOD AND SYSTEM FOR PROTECTION ACCESS AND OPERATION OF IO DEVICES USING CREDENTIALS”, which is assigned to the common assignees of the present invention. It should be noted that the management entity may be centralized or distributed, depending on the specific implementation of system 100.

The device credential may identify the consumer willing to receive messages from other consumer applications and/or willing to advertise its memory for direct memory access by other consumers as the owner of the virtual device (hereinafter defined as an “owner”), and may grant him execution rights to an IO request, a sequence of IO requests, an IO program, or a set of IO programs on the virtual device, that are privileged to the owner of the VD.

The owner may be allowed to create two types of resources on the VD it owns:

A connection resource for receiving messages, e.g., “ConResource B” 62, “ConResource A” 72 and “ConResource Y” in VD A 60, VD B 70 and VD C 80, respectively. The connection resource may be associated with a “Receive Queue”. Accordingly, the owner of the connection resource may be allowed to pre-post host buffers to this queue, and the consumer (hereinafter defined as a “user”) which may be willing to send messages to the “owner” consumer may be allowed to send messages to be placed into these buffers on FIFO principles.

A memory resource for allowing direct memory accesses, e.g., “MemResource X” 74 in VD B 70. The memory resource may be associated with the advertised memory region.

In accordance with an embodiment of the present invention a “user” may be required to establish a communication path with him. As a result of the communication path establishment, a connection resource may be created on the virtual device of the owner. The user may be granted with a credential allowing him to access the resource and to execute an IO request, a sequence of IO requests, an IO program, or a set of IO programs which are allowed to “users” with respect to this resource, for example “send message”. It should be noted that a “user” which may be willing to access remote memory belonging to the “owner” consumer, may have to get user memory window credentials to the corresponding memory resource as will be described in details below.

In the example shown in FIG. 1 consumer A 12, Consumer B 22 and Consumer C 32, each belong to a different host, create their virtual devices VD A 60, VD B 70, and VD C 80, respectively on the host-to-host device controller 50. Consumers A and B that may be willing to communicate with each other, create respective communication resources on their own devices. Accordingly, consumer A may create a connection resource B “ConResource B” 62 on VD A 60 and it may grant consumer B an access to this resource, while consumer B may create a connection resource A “ConResource A” 72 on VD B 70, and it may allow consumer A to access it. As shown in FIG. 1, consumer B may also create a memory resource for consumer X, “MemResource X” 74, allowing consumer X a direct access to the memory of consumer B. Consumer C may create a connection resource “ConResource Y” 82, for the usage of consumer Y.

In accordance with embodiments of the present invention, owner and user consumers may be allowed to execute an IO request, an IO program, e.g., a sequence of IO requests, or a set of IO programs on virtual devices. Owner consumers may use and execute them on the resources of its own virtual device, whereas user consumer may use and execute them on resources of virtual devices of other consumers. Upon completion of the execution of the IO requestor of the IO program, the output may be sent to the consumer that initiated the IO request or IO program. Further details are provided in detail below.

The establishment of the connection between consumers and the various communication operations between them will be described below in details.

### Connection Establishment

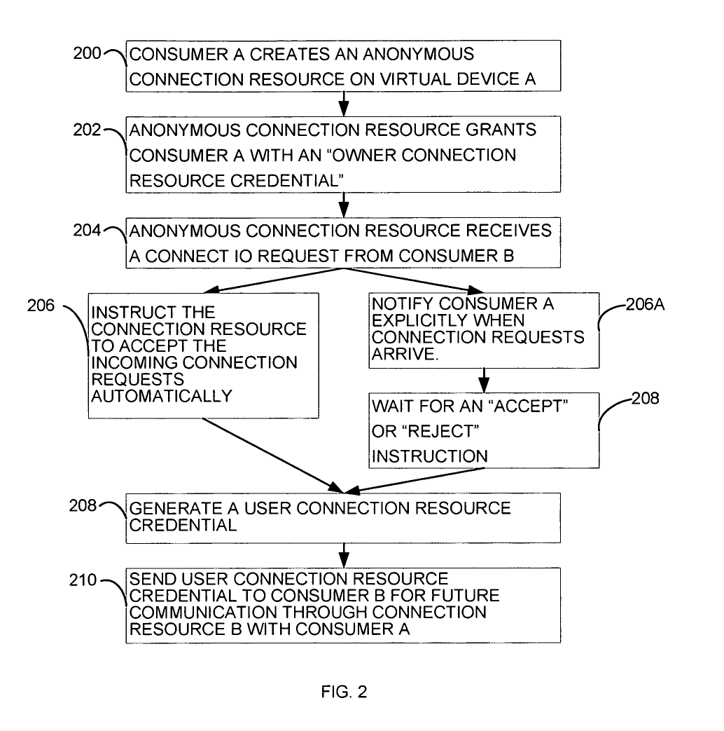

Reference is now made to FIG. 2 which is a flow chart diagram of a method for establishing a connection between two consumer applications, in accordance with an embodiment of the present invention. It should be noted that many connections may be established between the same consumers, and each connection may be established as follows.

An owner consumer A which may be willing to receive messages from other consumers, may create (step 200) an anonymous connection resource allocation on its virtual device, e.g., a connection resource without a corresponding user consumer. The connection resource allocation may be created in the owner's virtual device upon receipt of a “connection resource allocation” IO request that may include a credential granted to the owner consumer, and port as parameters:
connection resource allocation=[owner credential, port]

An IO program located in the virtual device of consumer A, the owner consumer, may process the connection resource allocation request and create the connection resource. It may then grant (step 202) consumer A with an “owner connection resource credential”.

A user consumer B which may be willing to send message to consumer A may send a connection IO request to virtual device A of consumer A. As a result, the virtual device A may receive (step 204) a connect IO request from consumer B which may include the “user” device credential and the port as parameters:
connect=[user credential, port]

Depending on a policy set by consumer A, it may either instruct (step 206) the connection resource to accept the incoming connection requests automatically or to notify (step 206A) consumer A explicitly when connection requests arrive. In the latter case consumer A is required to respond with an “accept” or “reject” instruction.

In both cases, when a connection request is accepted the anonymous connection resource may become a connection resource B. Accordingly, Host-to-host device controller 52 may generate (step 208) a user connection resource credential and send (step 210) it to consumer B for future communication through connection resource B with consumer A.

### Post Connection Establishment Operations

After a connection is established between an owner consumer and a user consumer, e.g., consumer A and B, respectively, in the example above, consumer A may send a “post receive buffer” IO message to verify that it has the required space in virtual device A to receive the messages from consumer B. Consumer A may include in the “post receive buffer” IO message his owner device credential to authenticate his rights as the owner of the virtual device, and the buffer length as parameters:
post receive buffer=[owner credential, buffer]

Each “post receive buffer” IO message may be sent from the owner consumer, e.g., consumer A, through the respective host gateway, e.g., HG A, to the host-to-host device controller. The host gateway may generate a credential, such as a window credential, which may protect the memory from subsequent non-authorized access. The creation of window credentials is described in U.S. Patent Application Ser. No. [Attorney docket IL920050027US1], titled “A METHOD AND SYSTEM FOR MEMORY PROTECTION AND SECURITY USING CREDENTIALS”, filed on Jan. 17, 2006 and assigned to the common assignees. The window credential may be associated with the connection resource and stored within its context on the host-to-host device controller 50.

When a user consumer, e.g., consumer B, is willing to send messages to the owner consumer, e.g., consumer A, the following operations may be executed.

Consumer B may submit a “Send” IO request to HG B. The parameters of the IO request may include the device resource credential which authenticates consumer B “user” right to access virtual device A connection resource, and the local memory region capability (e.g., Scatter-Gather List, where each element may include address, length and access permission):
send=[user credential, memory region capability]

HG B may generate a window credential and send it together with the “Send” IO request to virtual device A on the the host-to-host device controller. Optionally, HG B may append predefined amount of data payload, referred herein as immediate data. In this case, if the size of the immediate data covers the entire message, the window credential is not sent.

virtual device A may process the IO request. It may access the connection resource on virtual device A and verify whether there are available receive buffers to adapt the received message. When no buffers were pre-posted virtual device A may abort the received request and sends the corresponding status back to HG B which may forward it to Consumer B.

When the receive buffers are available, immediate data (if exists) may be sent to them in a direct memory access (DMA) operation, via HG A, using receive buffer memory window credential stored within the device connection resource. Next, a “read” request may be sent to HG B to bring remaining data payload (if needed). The read request may be processed by HG B, and the read data may be sent back to virtual device A. The latter may deliver the data to the pre-posted buffers and may generate a “completion” request (if asked for) to Consumer A, tho whom the buffers belong.

An owner consumer may be willing to receive messages from many consumers. In this case the owner consumer may create a on his virtual device a shared connection resource associated with his receive queue. Consumers that are willing to access the shared connection resource, may issue IO request “ConnectShared Resource”, providing their “user” device credential and port as a parameters. The virtual device of the owner device may send back to the consumer the “user” shared resource credential which grants him a right to send messages with respect to the shared connection resource.

### Multicasting

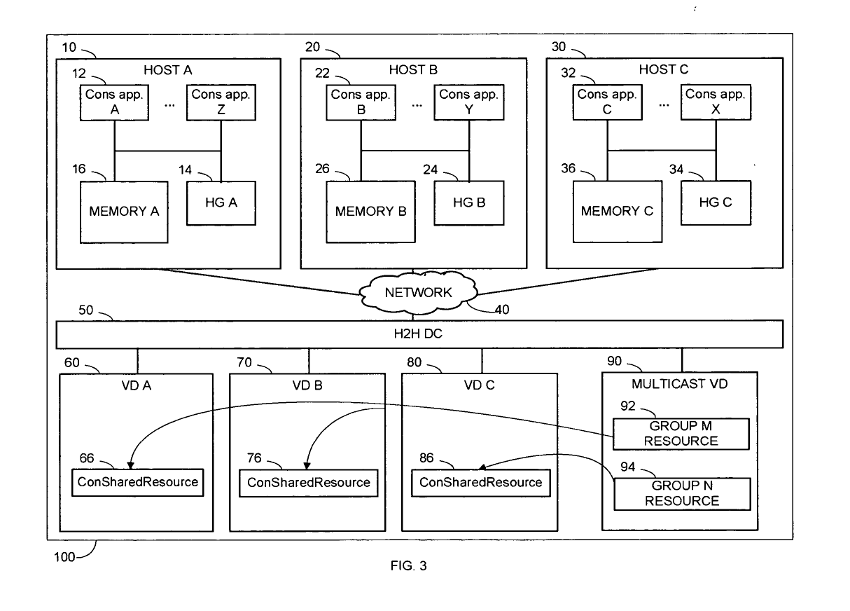

Reference is now made to FIG. 3 which a schematic block diagram of system for host-to-host multicast communication, in accordance with an embodiment of the present invention. Elements that were previously described will not be described again to maintain the simplicity of the description.

Host-to-host device controller may include a multicast virtual device 90 to control all multicast activities. A multicast group, e.g., multicast group M, may be represented as a resource on multicast virtual device 90. To join a multicast group, a user consumer may send a special IO request to multicast virtual device 90. When the consumer is allowed to join the multicast group, a corresponding “user resource credential” may be granted to him in response. This credential is required to be provided in each message sent to multicast group. Upon receipt of a message targeting one of the multicast groups, the host-to-host device controller may duplicate the message to the shared connection resources of the virtual devices owned by the multicast group members.

### Remote Direct Memory Access Procedures

In accordance with an embodiment of the present invention, the system for host to host communication allows remote direct memory access (DMA) read and write operations between consumers located on different hosts.

To enable these RDMA operations, the addressed memory region should be first advertised to the initiator consumer. The advertising procedure may supply the device credential to the consumer that initiates the memory access operation.

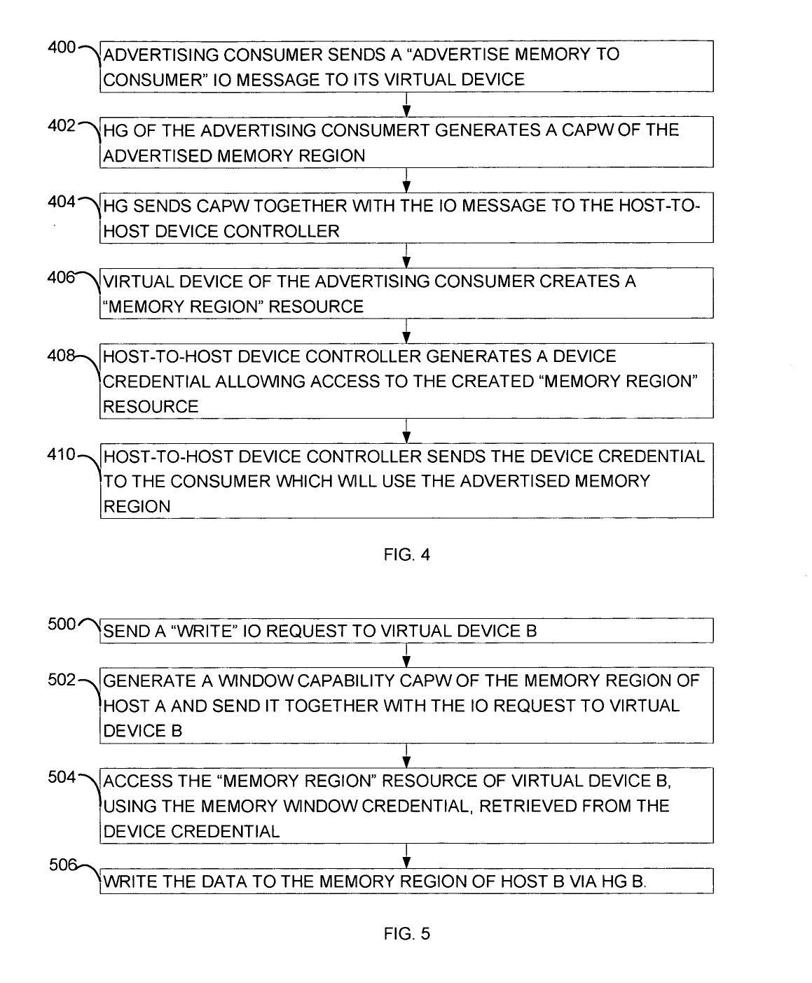

Reference is now made to FIG. 4 which is a schematic flow chart diagram of a method for memory advertising, in accordance with an exemplary embodiment of the present invention. In this example, consumer B may advertise a memory region of Host B to consumer A.

Consumer B may initiate the procedure by sending (step 400) an “Advertise Memory To Consumer” IO message to virtual device B in the host-to-host device controller. The parameters of the IO message may include the owner device credential, identifying Consumer B as the owner of virtual device B, consumer ID, identifying the consumer to whom the credential should be sent, and Memory B region capabilities, e.g., address, length, access permission:
“Advertise Memory To Consumer”=[owner credential, consumer ID, memory region capabilities]

When the IO message is processed by HG B, HG B may generate (step 402) a memory window credential CAP_{W} of the Memory B region and it may send it (step 404) together with the IO message to the host-to-host device controller. Virtual device B may receive the IO message and using the services of the host-to-host device controller, it may create (step 406) a “memory region” resource on the virtual device B. The resource may include the memory window credential CAP_{W}. Next, the host-to-host device controller may generate (step 408) a device credential allowing access to the created “memory region” resource, and it may send it (step 410) to consumer A, using the send post connection procedure described above.

Another option is for the host-to-host device controller to generate resource credential and pass it back to the advertising consumer B. The latter should send it to the consumer A.

Reference is now made to FIG. 5 which is a flow chart diagram of a method for remote direct memory access write operation, in accordance with an exemplary embodiment of the present invention. In this example, consumer A may execute a write transaction to the memory region of host B. The addressed memory region of host B has been advertised to consumer A as described above, and corresponding “memory region” resource have been created on virtual device B.

Accordingly, consumer A may send (step 500) a “Write” IO request to virtual device B. Together with the IO request, consumer A may supply the capability (device credential, address and length) of the memory region of host B and the capability (address, length, access permission) of the local memory region, the memory region of host A. HG A may generate (step 502) a window capability CAP_{W} of the memory region of host A and it may send it together with the IO request to virtual device B. To improve performance, HG A may attach to the IO request a predefined amount of data payload, referred herein as immediate data. The maximum size of the immediate data may be negotiated between HG A and the host-to-host device on the earlier stages, e.g., when the connection is established. If the entire data payload fits the allowed immediate data size, no window credential is sent by the HG A.

Optionally, when the data payload size exceeds the size of immediate data supplied with the IO request, upon receipt of the “Write” IO request, virtual device B may execute a “read” transaction towards the memory region of host A. A window credential of that region is supplied. The transaction may be processed by HG A and the data may be returned back to virtual device B.

Next, the host-to-host device controller may access (step 504) the “memory region” resource of virtual device B, using the memory window credential, retrieved from the device credential, and it may write (step 506) the data to the memory region of host B via HG B.

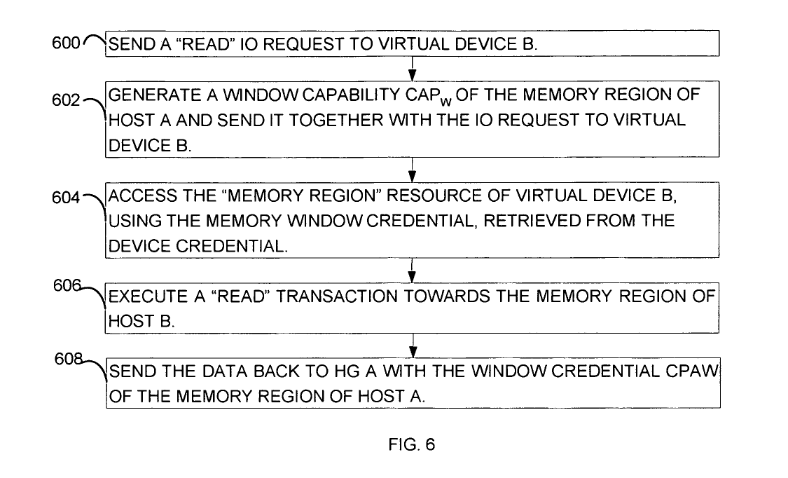

Reference is now made to FIG. 6 which is a flow chart diagram of a method for remote direct memory access read operation, in accordance with an exemplary embodiment of the present invention. In this example, consumer A may execute a read transaction from the memory region of host B. The addressed memory region of host B has been advertised to consumer A as described above, and corresponding “memory region” resource have been created on virtual device B.

Accordingly, consumer A may send (step 600) a “Read” IO request to virtual device B. Together with the IO request, consumer A may supply the properties (device credential, address and length) of the memory region of host B and the capability (address, length, access permission) of the local memory region, the memory region of host A. HG A may generate (step 602) a window credential of the memory region of host A and it may send it together with the IO request to virtual device B.

Upon receipt of the “Read” IO request, virtual device B may access (step 604) the “memory region” resource of virtual device B, using the memory window credential, retrieved from the device credential. It may then execute (step 606) a “read” transaction towards the memory region of host B. The transaction may pass through HG B which may validate the correctness of the transaction and initiate the DMA operation to retrieve the read data.

Next, virtual device B may send (step 608) the data back to HG A with the window credential of the memory region of host A. HG A may validate the access of the data and complete the DMA operation to the respective memory region.

As briefly mentioned above, in accordance with embodiments of the present invention, owner and user consumers may be allowed to execute an IO request, an IO program, e.g., a sequence of IO requests, or a set of IO programs on virtual devices. Owner consumers may use and execute them on the resources of its own virtual device. For example, an owner consumer may send to its virtual device one IO program for generation of many connection resources (and to pre-post requests to these connection resources) and memory resources to advertise a memory region.

User consumer may use and execute an IO request, an IO program, e.g., a sequence of IO requests, or a set of IO programs on resources of virtual devices of other consumers. For example, a user consumer may execute a series of RDMA write operations to a memory resource of an owner consumer, to send messages to other consumers using their connection resource, and to have all operations encapsulated in one IO program.

Upon completion of the execution of the IO request or of the IO program, the output may be sent to the consumer that initiated the IO request or IO program, i.e., to the owner consumer in the first example and to the user consumer in the second example.

In the description above, numerous specific details were set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code that embodies aspects of the present invention is typically maintained in permanent storage, such as a computer readable medium. In a client-server environment, such software programming code may be stored on a client or server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software. For example, host-to-host device controller 50 may be embodied in computer software, or alternatively, in part or in whole using hardware components.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A system for host to host communication, said system comprising:
a first host of a first consumer application, said host is arranged to allow said consumer application to communicate with a second consumer application coupled with a second host;
a network arranged to connect said first and second hosts; and
a host-to-host device controller arranged to control communication protocols between said first and second hosts to allow said first and second consumer applications to communicate with each other.

2. The system of claim 1, wherein said first consumer application, in order to communicate with said second consumer application, creates a virtual device in said host-to-host device controller, said virtual device is arranged to receive messages from said second consumer application, and further arranged to directly access to memory coupled with said first consumer application.

3. The system of claim 2, wherein said first consumer application is arranged to create a connection resource to receive messages from said second consumer application, and a memory resource to allow second consumer application direct access to the memory coupled with said first consumer application.

4. The system of claim 1, wherein said host-to-host device controller further comprises a multicast virtual device arranged to send a message from said first consumer application to a plurality of consumer applications.

5. The system of claim 2, wherein said host-to-host device controller is further arranged to enable remote direct memory access (RDMA) read and write operations between said first and second consumer applications.

6. The system of claim 2, wherein said virtual device is further arranged to execute any of the following: an IO request, a sequence of IO requests, an IO program, or a set of IO programs, received from said first or second consumer application.

7. A computer implemented method for establishing a communication between a first consumer application which is located on a first host to a second consumer application which is located on a second host, said method comprising:
creating an anonymous connection resource allocation on behalf of said first consumer application on a virtual device of said first consumer application;
granting said first consumer application a resource credential from a first type, said resource credential allows execution of operations on said virtual device; and
upon receipt of a connection request from said second consumer application, sending an instruction to said second consumer application based on a policy of said first consumer application.

8. The method of claim 7, wherein said step of sending said instruction further comprises sending an accept instruction to said second consumer application automatically based on said policy of said first consumer application.

9. The method of claim 7, wherein said step of sending said instruction further comprising:
notifying said first consumer application based on said policy of said first consumer application that said connection request from said second consumer application is received; and
sending an accept or reject instruction received from said first consumer application.

10. The method of claim 7, wherein said resource credential from said first type is a connection resource credential.

11. The method of claim 10, wherein if said instruction sent to second consumer application is to accept the connection between said consumer applications, said method further comprising:
generating a connection resource credential from a second type; and
sending said connection resource credential from said second type to allow future communication of said second consumer application with said first consumer application via said virtual device,
wherein said steps of generating and sending are executed by said first type consumer.

12. The method of claim 11, further comprising allowing said first consumer application to receive messages from said second consumer application, and allowing said second consumer application to send messages to said first consumer application.

13. The method of claim 7, wherein said resource credential from said first type is a shared resource credential.

14. The method of claim 13, further comprising allowing said first consumer application to receive messages from multiple consumer applications.

15. The method of claim 7, further comprising allowing said second consumer application to send a message to a plurality of consumer applications via a multicast virtual device, said message include a multicast connection resource credential.

16. The method of claim 7, wherein said operations include any of the following: an IO request, a sequence of IO requests, an IO program, or a set of IO programs, received from said first consumer application.

17. A method for advertising a first memory region of a first consumer application which is located on a first host for a read and write remote direct memory access (RDMA) operations from a second consumer application which is located on a second host to said first memory region, said method comprising:
sending an IO request from a first type to a host-to-host device controller to advertise said first memory region;
generating a memory window credential (CAP_{W}) of said first memory region;
sending said IO request and said CAP_{W} to a virtual device of said first consumer application, said virtual devise is located on said host-to-host device controller;
creating a memory region resource on said first virtual device, said first virtual device is coupled with said CAP_{W};
generating a device credential to allow access to said first memory region resource; and
sending said device credential to said second consumer application.

18. The method of claim 17, wherein said read and write RDMA operations include any of the following: an IO request, a sequence of IO requests, an IO program, or a set of IO programs, received from said first consumer application.
